(19) United States
(12) Patent Application Publication
(10) Pub. No.: US 2009/0201160 A1
(43) Pub. Date: Aug. 13, 2009

(54) PET DETECTOR

(76) Inventor: EDMUND GENE ACREY, Riverside, CA (US)

Correspondence Address: BUUS, KIM, KUO, & TRAN, APC, 4675 MacArthur Court, Suite 590, Newport Beach, CA, 92660, US

(21) Appl. No.: 12/029,261

(22) Filed: Feb. 11, 2008

(51) Int. Cl. G08B 23/00

(52) U.S. Cl. 340/573.3

(57) ABSTRACT

The present invention is a pet actuated signaling device that generally comprises of at least one figurine having a motion detector sensor that is housed within the figurine; and a wireless based remote receiver placed inside the building. The motion detector sensor is activated on at least one stimulus induced when the pet passes across the figurine that subsequently transmits a signal to the wireless based remote receiver. The receiver emits a sound alert that informs the owner that the pet wishes to enter the home. The figurine resembling a pet can be positioned and angled in a way to obtain a wider range. In one preferred embodiment, the sound alert can be in the form of a dog bark or cat meow.

### BACKGROUND OF THE INVENTION

(1) Field of the Invention

The field of the invention is related to pet actuating notification systems for owners, in particular, to an automated motion detecting device for signaling the owner the ingress of pets.

(2) Description of Related Art

House pets, such as cats and dogs normally indicate their desire to be let into or out of the house by meowing, barking or by scratching the door. The meowing can be annoying to neighbors and others and is not always effective as the pet owner may attribute it to other reasons. Also, scratching can result in damage to the door and thus, is not desirable. The provision of a pet door is not always an effective solution as such a door permits unrestricted egress and ingress by the pet and by other small animals and rodents. In order to avoid the above problems, pet operable doorbells have been proposed to provide a signaling means usable by the pet. For example in U.S. Pat. No. 4,908,484 issued to Gunoff, one such doorbell operator includes a spring-loaded platform with switch contacts and is intended to be placed beside the door with the pet being trained to sit on the platform thereby closing the contacts to actuate the household doorbell. As this device is connected to the existing doorbell wiring, however, it is not readily portable or suitable for use at a door not equipped with a bell. Also, when the device is placed out of doors and intended for use by a relatively small animal, snow accumulation and the like may also actuate the switch.

Similarly, another inventive device for pet notification includes a base plate and an enclosing cover pivotally mounted to the base plate. For example in U.S. Pat. No. 5,952,926 issued to Syverson, the enclosing cover is movable from one position to another position when the enclosing cover is depressed by a pet when it desires to enter the home. When the enclosing cover is depressed, a transmitter mounted to the base plate is activated and sends a signal to a receiver so that the speaker associated with the receiver produces a sound to alert a person inside the home to let the pet inside. The major problem with this design is that the system could be incorrectly triggered if the pet is not adequately trained.

Security systems commonly use motion detector sensors to detect the presence of an intruder, such as an individual or an animal to a house or other buildings. These systems commonly use infrared or other passive sensors that detect the body heat, pressure exerted, weight of the body, or the like. These motion detectors can be used as an activity meter to detect the animal stimulus. Also the sensors can be arranged in a manner to detect the stimulus and subsequently activate a receiver means to attract the attention of the pet owner.

Most of the motion detector sensors are provided with a sensing element responsive to infrared or other specific radiations of the spectrum and is mounted in its own housing—commonly referred to as the “sensor head” that also typically contains associated optical elements and electronic circuitry. In a particular installation the sensor head may be aimed at a desired height or turned to particular direction. However the adjustments are usually made manually to components that are within a housing of the sensor. Once the housing is closed and the sensor is installed, no further changes can be made. If the sensitivity is too great, the pet will trigger the alarm. Moreover, variations in sensitivity can occur as the sensor ages, or due to environmental factors such as dust. Furthermore, the home owner may acquire a larger pet, which requires the sensitivity to be reduced.

For alleviating these problems and to prevent passage of unwanted stray animals and allow only selective carry-in rodents & animals, pet doors have been designed with magnetically operable latches as described in U.S. Application No. 20070089684 (Brooks). The Latch is usually powered by battery and is operable only when a pet with a magnetic tag is detected. This design attempts to allow selective operation of a door by a selected animal with the appropriate tag. It is found that the pet door activated by magnetic latches would not always work satisfactorily with larger animals because the magnet around their neck would be large in size and this is not acceptable and would be uncomfortable for the animal to wear.

All referenced patents, applications and literatures are incorporated herein by reference in their entirety. Furthermore, where a definition or use of a term in a reference, which is incorporated by reference herein is inconsistent or contrary to the definition of that term provided herein, the definition of that term provided herein applies and the definition of the term in the reference does not apply. The invention may seek to satisfy one or more of the above-mentioned desire. Although the present invention may obviate one or more of the above-mentioned desires, it should be understood that some aspects of the invention might not necessarily obviate them.

In these respects, the pet detector device according to the present invention substantially departs from the conventional concepts and designs of the prior art, and so doing provides a pet detector device that is not anticipated, rendered obvious, suggested, or even implied by any of the prior art pet detectors, either alone or in combination thereof.

### BRIEF SUMMARY OF THE INVENTION

In view of the foregoing disadvantages inherent in the known types of household pet detecting devices and means now present in the prior art, the general purpose of the present invention, which will be described subsequently in greater detail, is to provide a pet actuated signaling device that automatically informs the owner the presence of a pet that is ready to ingress by generating a sound alert.

Another object of the present invention is to provide a pet actuated signaling device that is a figurine resembling a pet;

Another object of the present invention is to provide a pet actuated signaling device that is simple, portable and adjacent to the door;

Another object of the present invention is to provide a pet actuated signaling device that is positioned outside the building adjacent to the door;

Another object of the present invention is to provide a pet actuated signaling device that activates on at least one stimuli of the pet and that generates an automated cat meow or dog bark sound to alert the owner that his pet wishes to enter or exit the home;

Another object of the present invention is to provide a pet actuated signaling device that generates a sound alert to notify the owner that the pet wishes to enter the home;

Another object of the present invention is to provide current owners of pet doors an opportunity to keep such a door but add the benefits of the present invention's notification signaling device to allow the owner to determine if the pet is attempting to bring back inside any unwanted items.

To attain this, the present invention in one embodiment generally comprises of at least one figurine having a motion detector sensor that is housed within the figurine; and a wireless based remote receiver placed inside the building. The figurine resembles a pet such as a cat or dog or the like which can emit a cat or dog sound alert and can be positioned and angled in at least one direction adjacent to the door outside the house to alert the homeowner when the pet wishes to enter or exit the home. In another embodiment of the invention a plurality of figurines can be positioned in a manner to obtain a wider range.

In typical use, the motion detector sensor is activated on at least one stimulus induced when the pet passes across the figurine and is attempting to bring in unwanted rodents or items back inside the house. Upon activation of the sensor, a signal is transmitted to the wireless based remote receiver that emits a sound alert. This sound signal informs the owner that the pet wishes to enter the home. The receiver can be placed inside the building or can be carried by the owner. The owner can view the pet before allowing the pet to enter back into the house and can prevent the pet bringing unwanted stuffs inside. Further, the invention does not necessitate a pet door and hence does not limit the size of the pet.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting. To accomplish the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWING(S)

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of a pet detecting device motion detector sensor housed within a pet like figurine;

FIG. 2 is a perspective view of a plurality of figurines positioned and angled at various directions;

FIG. 3 is a perspective view of a pet activated signaling device in use;

### DETAILED DESCRIPTION OF THE INVENTION

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claims are set forth below in a certain combination, it must be expressly understood that the invention includes other combinations of fewer, more or different elements, which are disclosed herein even when not initially claimed in such combinations.

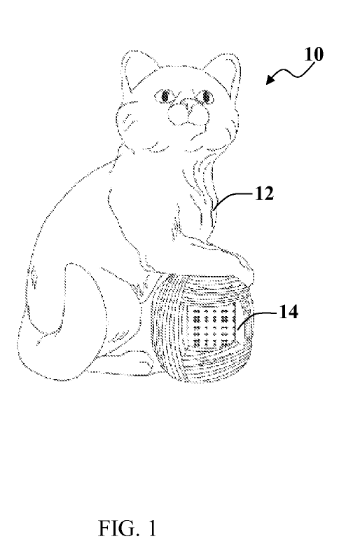

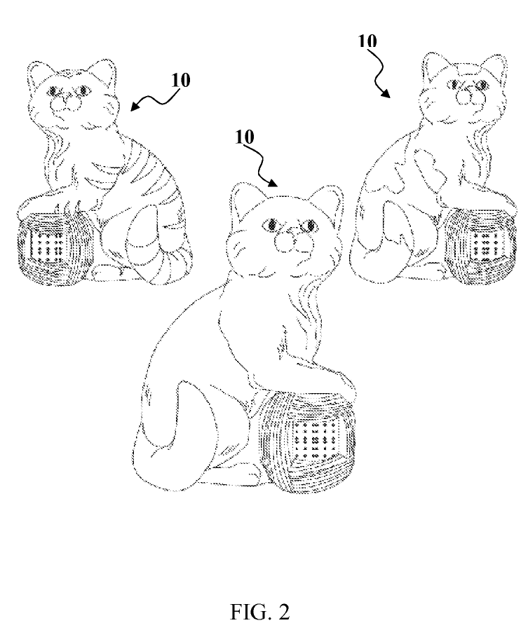

Referring now to the drawings, which are provided by way of illustration and example, and wherein like reference numerals designate like or corresponding elements among the several views, there is shown in FIG. 1, the pet detecting device 10 having a motion detector sensor 14 housed within a figurine 12 resembling a pet, exemplified as a cat. The detector sensor 14 is activated when a stimulus is induced by a pet 24 while passing across the figurine 10. The motion detector sensor 14 is protected within the figurine 12 in a weather resistant manner. Turning now to the embodiment of FIG. 2, a plurality of figurines 10 having different patterns are provided. The figurines 10 are desired to be positioned at various angles and places adjacent to the entrance 22 of the house 20 to obtain a wider range. The figurines 10 are advantageous in aspects of simplicity, lightweight and portable in nature.

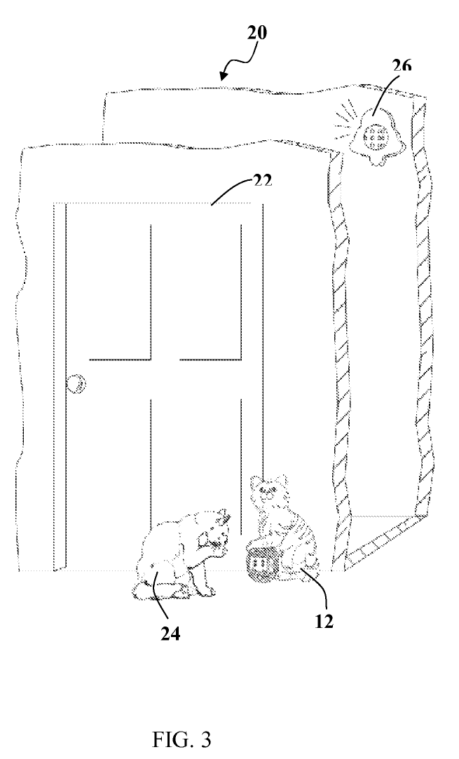

As shown in FIG. 3, the figurine 12 resembling a cat is placed outside the house 20 adjacent to a door 22 through which the pet 24 is intended to ingress the house 20. The motion detector sensor 14 is activated by an animal stimulus such as temperature, weight, pressure or the like, when the pet 24 enters the range of the sensor 14. This induces a signal generating condition and transmits the signal to the wireless based remote receiver 26. The receiver 26 that is usually placed inside the home 20 operationally produces a sound alert to notify the owner (not pictured) that the pet 24 wishes to enter the home 20. The receiver 26 can also be carried by the owner (not pictured). As the motion detector sensor 14 is activated upon an animal stimulus, the pet detector device 10 obviates the need to train the pet 24.

Thus, specific embodiments and applications of the pet detector device have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A pet actuating signaling device comprising:
at least one figurine having a motion detector sensor that produce signals on activation;
a wireless based remote receiver means for receiving the signal from the motion detector sensor;
wherein the motion detector sensor is activated when a pet passes at least one figurine and the receiver means is signaled which emits a sound to alert the owner that the pet wishes to enter the home.

2. The device as recited in claim 1, wherein the motion detecting sensor is incorporated within a housing, the housing being generally a figurine resembling a pet such as a dog, cat, and the like.

3. The device as recited in claim 1, wherein the figurine incorporating the motion detector sensor is positioned outside the house adjacent to the door.

4. The device as recited in claim 1, wherein the wireless remote receiver means can be placed inside the house is signaled to notify the owner the presence of the pet that wishes to enter the house.

5. The device as recited in claim 1, wherein the wireless remote receiver means can be carried by the owner to receive the signal from the motion detector sensor.

6. The device as recited in claim 1, wherein a plurality of figurines can be positioned at different angles adjacent to the entrance of the house to cover a relatively wide area.

7. The device as recited in claim 1, wherein at least one figurine incorporating the motion detector sensor is portable.

8. The device as recited in claim 1, wherein the motion detector sensor is activated on at least one stimuli of the household pet.

9. The device as recited in claim 1, wherein said signals activated are in the form of a dog bark or cat meow sound.
